(19) United States
(12) Patent Application Publication
(10) Pub. No.: US 2026/0145142 A1
(43) Pub. Date: May 28, 2026

(54) FLUID FILTRATION MEMBRANES

(71) Applicant: Khalifa University of Science and Technology, Abu Dhabi (AE)

(72) Inventors: Shadi Wajih HASAN, Abu Dhabi (AE); Hanaa Mohamed Samy Mohamed Saber HEGAB, Abu Dhabi (AE); Farah Jehad Khalil ABUHANTASH, Abu Dhabi (AE)

(21) Appl. No.: 18/958,560

(22) Filed: Nov. 25, 2024

(51) Int. Cl. B01D 69/14; B01D 67/00; B01D 69/02; B01D 71/48

(52) U.S. Cl. CPC B01D 69/14111; B01D 67/00793; B01D 69/02; B01D 69/148; B01D 71/48; B01D 2323/56; B01D 2325/02833; B01D 2325/36

(57) ABSTRACT

A membrane includes a polymeric material; and a nanomaterial dispersed in the polymeric material, wherein the nanomaterial includes a carbon nanotube material, and the membrane is hydrophilic. A method for forming a membrane includes distributing a nanomaterial in a solvent to form a first mixture, wherein the nanomaterial includes a multi-walled carbon nanotube material; mixing one or more polymeric materials with the first mixture to form a second mixture; introducing a non-solvent sufficient to induce phase separation; and drying to form a hydrophilic membrane.

### TECHNICAL FIELD

The subject matter disclosed herein relates to membranes and more particularly to fluid filtration membranes. Methods for forming such membranes are also disclosed herein.

### BACKGROUND

The continuous need for water and its increasing scarcity are major forces behind the increased development of various water treatment technologies. Membranes can be used for various fluid treatment applications. Membrane separation processes can be categorized into microfiltration, ultrafiltration, nanofiltration, and reverse osmosis. Microfiltration and ultrafiltration can target particulate matter and macromolecules, while nanofiltration and reverse osmosis can separate solutes based on molecular size and charge. The growing emphasis on green chemistry has propelled the development of environmentally friendly and recyclable membranes.

Green polymeric membranes aim to eliminate toxic waste, reduce energy consumption, and use environmental solvents. For example, polylactic acid (PLA) is a biodegradable polymer with the potential for replacing conventional fossil-based materials for membrane fabrication due to its high strength, high modulus, biocompatibility, and recyclability with composting processes. Nevertheless, the hydrophobic nature of these membranes can alter the effectiveness in some applications, such as oil-water filtration. Accordingly, it would be beneficial to provide membranes exhibiting improved rejection of undesirable substances and improved fouling resistance.

### SUMMARY

According to one aspect, a membrane includes a polymeric material; and a nanomaterial dispersed in the polymeric material, wherein the nanomaterial includes a carbon nanotube material, and the membrane is hydrophilic.

According to another aspect, a mixed matrix membrane includes a polymeric material including polylactic acid (PLA); and a nanomaterial including at least one of: (1) a modified multi-walled carbon nanotube material; and (2) a nanocomposite including multi-walled carbon nanotube material and titanium dioxide.

According to another aspect, a method for forming a membrane includes distributing a nanomaterial in a solvent to form a first mixture, wherein the nanomaterial includes a multi-walled carbon nanotube material; mixing one or more polymeric materials with the first mixture to form a second mixture; introducing a non-solvent sufficient to induce phase separation; and drying to form a hydrophilic membrane.

### BRIEF DESCRIPTION OF THE DRAWINGS

FIG. 1 illustrates a method for forming a membrane, according to some embodiments.

FIG. 2 illustrates an example process for forming nanomaterial, according to some embodiments.

FIG. 3 illustrates an example process for forming a membrane, according to some embodiments.

FIG. 4A illustrates scanning electron microscope (SEM) images of multi-walled carbon nanotubes (MWCNTs) at different magnifications, according to some embodiments.

FIG. 4B illustrates SEM images of functionalized multi-walled carbon nanotubes (f-MWCNTs) at different magnifications, according to some embodiments.

FIG. 5A illustrates energy dispersive X-ray spectroscopy (EDS) mapping of MWCNT nanomaterial, according to some embodiments.

FIG. 5B illustrates EDS mapping of f-MWCNT nanomaterial, according to some embodiments.

FIG. 6 illustrates X-ray Diffraction (XRD) analysis of MWCNT and f-MWCNT nanomaterial, according to some embodiments.

FIG. 7A illustrates EDS surface elemental mapping of a fabricated membrane, according to some embodiments.

FIG. 7B illustrates EDS surface elemental mapping of a fabricated membrane, according to some embodiments.

FIG. 7C illustrates EDS surface elemental mapping of a fabricated membrane, according to some embodiments.

FIG. 7D illustrates EDS surface elemental mapping of a fabricated membrane, according to some embodiments.

FIG. 7E illustrates EDS surface elemental mapping of a fabricated membrane, according to some embodiments.

FIG. 8A illustrates SEM images of a membrane at the surface and cross-section, according to some embodiments.

FIG. 8B illustrates SEM images of a membrane at the surface and cross-section, according to some embodiments.

FIG. 9A illustrates SEM images of a membrane at the surface and cross-section, according to some embodiments.

FIG. 9B illustrates SEM images of a membrane at the surface and cross-section, according to some embodiments.

FIG. 9C illustrates SEM images of a membrane at the surface and cross-section, according to some embodiments.

FIG. 10 illustrates porosity, mean pore size, and water contact angle of membranes, according to some embodiments.

FIG. 11 illustrates thermogravimetric analysis (TGA) profiles for various membranes, according to some embodiments.

FIG. 12 illustrates zeta potential for various membranes, according to some embodiments.

FIG. 13 illustrates membrane performance profiles including water and emulsion permeation flux, and oil rejection, according to some embodiments.

FIG. 14A illustrates 3-cycle filtration of an oil-water emulsion, according to some embodiments.

FIG. 14B illustrates flux recovery ratio (Fᵣᵣ), total fouling ratio (Rₜ), reversible fouling ratio (Rᵣ), and irreversible fouling ratio (Rᵢᵣ) of the 1st cycle, according to some embodiments.

### DETAILED DESCRIPTION

Embodiments of the present disclosure include novel membranes, filtration systems, and methods of filtering liquids. Membranes of the present disclosure can include composite filtration membranes. For example, the composite filtration membrane can include a combination of two or more components with different physical and/or chemical properties. These composite filtration membranes can be utilized for various liquid filtration applications, such as ultrafiltration or nanofiltration. Further, filtration systems of the present disclosure are capable of operating (and removing contaminants) without the use of added chemicals.

Membranes of the present disclosure can include one or more organic materials and one or more inorganic fillers. Membranes of the present disclosure generally include one or more polymeric materials and one or more additives. In one example, membranes of the present disclosure include a mixed matrix membrane (e.g., at least one additive is mixed with at least one polymeric material before membrane casting). The membrane can be hydrophilic. In one non-limiting example, membranes of the present disclosure include a mixed matrix membrane, where the mixed matrix membrane is formed by at least partially dissolving at least one additive and the polymeric material/mixture before membrane casting. The mixed matrix membrane can be formed by non-solvent induced phase separation. The mixed matrix membrane can exhibit hydrophilic properties.

The polymeric material can include one or more natively hydrophobic polymers. The polymeric material can include one or more green polymers. Green polymers can be derived from renewable resources such as corn starch, sugar cane, and other plant-based materials. In one example, the polymeric material includes polylactic acid (PLA). PLA is a bio-based material that can be synthesized from non-toxic renewable resources. The polymeric material can include a green polymeric material, such as at least one of cellulose, chitosan, PLA, and polyhydroxyalkanoates. Other examples of polymeric materials include polysulfone, polyethersulfone (PES), polyvinylidene fluoride (PVDF), and polyvinyl chloride (PVC).

The additive can be dispersed in the polymeric material and/or distributed on a surface of the polymeric material. Therefore, the polymeric material can act as a matrix material. In one example, the additive is substantially homogeneously distributed throughout the bulk of the polymeric material. The additive can include a hydrophilic material. The additive can include a nanomaterial, such as a hydrophilic nanomaterial. In one example, the nanomaterial includes nanoparticles and/or nanotubes. Accordingly, the nanomaterial can exhibit one or more dimensions (width, length, particle size) ranging from 1 nm to 1000 nm. In one non-limiting example, the nanomaterial can exhibit one or more dimensions (width, length, particle size) ranging from 1 nm to 100 nm.

The nanomaterial can include a carbon nanotube material. The carbon nanotube material can include a multi-walled carbon nanotube (MWCNT) material. In one example, MWCNTs can include an array of cylinder-shaped material. MWCNTs can have native average diameters ranging from about 1 nm to about 100 nm. MWCNTs can have native average lengths of greater than 1 μm. MWCNTs can have native average lengths of greater than 3 μm. In one example, the nanomaterial includes a modified MWCNT, such as a functionalized multi-walled carbon nanotube (f-MWCNT) material. In another example, the nanomaterial includes a nanocomposite. The nanocomposite can include MWCNT and at least one additional component, where the at least one additional component is distinct from the MWCNT.

The nanomaterial can include a plurality of nanoparticles and/or nanotubes. As discussed, the nanomaterial can include modified MWCNT material. A pristine MWCNT (or MWCNT-COOH) material can be modified to form the modified MWCNT material, where the modified MWCNT material is more hydrophilic compared to pristine MWCNT material. The modified MWCNT material can be hydrophilic. The modified MWCNT material can include functionalized MWCNTs. In one non-limiting example, the pristine MWCNT can be modified using amino-SiO₂. The modified MWCNT material can be present as a plurality of hydrophilic nanotubes. The modified MWCNT material can be incorporated in and/or on the polymeric matrix to improve the hydrophilicity of the membrane. Improving the hydrophilicity can improve the water permeation rate and anti-fouling properties of the membrane in water filtration applications.

The nanomaterial can include Si (e.g., Silicon atoms), where a weight percentage of elemental Si based on the total weight of the nanomaterial is greater than about 2 wt. %. The nanomaterial can include Si (e.g., Silicon atoms), where a weight percentage of elemental Si based on the total weight of the nanomaterial is greater than about 5 wt. %. The nanomaterial can include Si (e.g., Silicon atoms), where a weight percentage of elemental Si based on the total weight of the nanomaterial is greater than about 10 wt. %. In one example, the nanomaterial includes Si, where a weight percentage of elemental Si based on the total weight of the nanomaterial ranges from about 2 wt. % to about 30 wt. %. In another example, the nanomaterial includes Si, where a weight percentage of elemental Si based on the total weight of the nanomaterial ranges from about 5 wt. % to about 20 wt. %. In another example, the nanomaterial includes Si, where a weight percentage of elemental Si based on the total weight of the nanomaterial ranges from about 10 wt. % to about 20 wt. %.

The modified MWCNT material can include f-MWCNT. In one example, the f-MWCNT includes at least one distinct functional group or surface compound compared to a pristine MWCNT material. The f-MWCNT material can include at least one amide bond. In one example, the f-MWCNT material includes at least one amine functional group. In one example, the f-MWCNT material includes amino-SiO₂ functionalized MWCNTs. In one example, the f-MWCNT material includes SiO₂ particles. In one example, the f-MWCNT material includes SiO₂ nanoparticles in contact with a surface of the MWCNT. In another example, the f-MWCNT material can be formed using amino functionalized—Fe₃O₄ nanoparticles. Therefore, the f-MWCNT material can include iron. In one non-limiting example, the f-MWCNT material including at least one amine functional group promotes desirable hydrophilicity to the membrane, improving efficiency for liquid filtration, such as filtration of oil-water-containing mixtures.

Methods of the present disclosure including forming amino-SiO₂ functionalized MWCNTs. The amino-SiO₂ functionalized MWCNTs can be formed by producing an ester intermediate using COOH functionalized multi-walled carbon nanotubes (MWCNTs-COOH). For example, the MWCNTs-COOH can be present in a solution or mixture and at least partially dissolved in a buffer and sonicated. Therefore, the MWCNTs-COOH can be added as crosslinkers to produce the ester intermediate. Producing the ester intermediate may include utilizing at least one of phosphate-buffer saline, 1-ethyl-3-(3-dimethylaminopropyl) carbodiimide hydrochloride (EDC), and N-hydroxysuccinimide (NHS). Then, a solution or mixture including amino-SiO₂ can be added. After or during amino-SiO₂ addition, blending and/or sonication can be performed to create an amide bond. Centrifugation can be used to collect nanomaterial. Then, the nanomaterial can be washed to remove excess or unreacted amino silica and dried.

The f-MWCNT material can include Si (e.g., Silicon atoms), where a weight percentage of elemental Si based on the total weight of the f-MWCNT material is greater than about 2 wt. %. In one example, the f-MWCNT material includes Si, where a weight percentage of elemental Si based on the total weight of the f-MWCNT material ranges from about 2 wt. % to about 30 wt. %. In another example, the f-MWCNT material includes Si, where a weight percentage of elemental Si based on the total weight of the f-MWCNT material ranges from about 5 wt. % to about 20 wt. %. In another example, the f-MWCNT material includes Si, where a weight percentage of elemental Si based on the total weight of the f-MWCNT material ranges from about 10 wt. % to about 20 wt. %.

The f-MWCNT material can include O (e.g., Oxygen atoms), where a weight percentage of elemental O based on the total weight of the f-MWCNT material is greater than about 2 wt. %. In one example, the f-MWCNT material includes O, where a weight percentage of elemental O based on the total weight of the f-MWCNT material ranges from about 2 wt. % to about 30 wt. %. In another example, the f-MWCNT material includes O, where a weight percentage of elemental O based on the total weight of the f-MWCNT material ranges from about 5 wt. % to about 20 wt. %. In another example, the f-MWCNT material includes O, where a weight percentage of elemental O based on the total weight of the f-MWCNT material ranges from about 10 wt. % to about 20 wt. %. Elemental weight percentages can be obtained from EDS elemental analysis.

In one example, when amino-SiO₂ is introduced to MWCNTs, the structure exhibits a bundle of coarse tubes with the amino-SiO₂ densely packed on the top surface of MWCNTs. The amino-SiO₂ nanoparticles can be grafted onto the MWCNTs-COOH. In one example, the amino-SiO₂ loading into the MWCNTs surface can generate enhanced surface roughness and external diameter compared to unfunctionalized MWCNTs. In contrast to unfunctionalized MWCNTs, the f-MWCNTs of the present disclosure can exhibit a noticeably broader and lower peak intensity, which can be attributed to the semicrystalline nature resulting from the grafting of amino-SiO₂. Adding the f-MWCNTs to the polymeric membrane can increase the pore size, porosity, and density of the membrane. Accordingly, membranes of the present disclosure include mixed matrix polymeric polylactic acid (PLA)/Amino-SiO₂ functionalized multi-walled carbon nanotubes (f-MWCNTs) membranes.

As discussed, the additive can include a composite material (e.g., nanocomposite). The composite can include MWCNT and at least one additional component, where the at least one additional component is distinct from the MWCNT. In one example, the composite includes a nanocomposite, including a plurality of composite nanoparticles and/or nanotubes. The nanocomposite can include one or more inorganic fillers. In one example, the nanocomposite can include MWCNT and a metal and/or a metal-containing compound. In one example, the metal-containing compound includes a metal oxide. For example, the metal oxide can include one or more of titanium dioxide (TiO₂), zinc oxide, aluminum oxide, and tin (IV) oxide. In one example, the metal oxide includes titanium dioxide, and optionally further includes at least one of zinc oxide, aluminum oxide, and tin (IV) oxide. TiO₂ exhibits excellent chemical stability, and TiO₂ can be added to improve the hydrophilicity of the membrane.

Methods of the present disclosure include forming the composite. MWCNTs-COOH can be mixed with a liquid (e.g., water) to form a first mixture. Before, simultaneously, and/or subsequently, a metal oxide of the present disclosure (e.g., rutile TiO₂) can be mixed (e.g., dissolved) in a liquid (e.g., water) to form a second mixture. TiO₂ nanoparticles can be used, such as a plurality of nanoparticles having an average particle size of less than about 1 μm. In one example, the TiO₂ nanoparticles have an average particle size ranging from about 1 nm to about 200 nm. The first mixture and/or second mixture can be separately mixed using stirring and/or agitation. The first mixture and second mixture can be combined. The combined mixture can be stirred, agitated, and/or sonicated, with various orders possible. In one example, the combined mixture is agitated at room temperature (e.g., about 20° C.), followed by sonication. The combined mixture can be heated. In one example, the combined mixture is heated to/at a temperature of greater than 60° C., greater than 70° C., or greater than 80° C.

The combined mixture can be subjected to H₂O evaporation. In one example, the metal oxide nanoparticles (e.g., TiO₂-containing nanoparticles) can chemically adsorb onto the carboxylic acid of the MWCNTs because of robust contacts. In another example, the metal oxide nanoparticles (e.g., TiO₂-containing nanoparticles) contacts/clings to the MWCNTs in one or more regions lacking COOH through electrostatic adsorption. In one example, TiO₂ can cling to the MWCNTs at these regions when the titanium ion and the surface electric charge of the MWCNTs attract each other. After H₂O evaporation, the formed product can be dried to form a fine composite powder. Therefore, the nanocomposite can include MWCNTs and TiO₂-containing nanoparticles. The TiO₂-containing nanoparticles can be in contact with a surface of the MWCNTs.

The weight percentage of the composite material in the membrane can range from about 0.1 wt. % to about 5 wt. %. In one example, the weight percentage of the composite material in the membrane can range from about 0.2 wt. % to about 3 wt. %. In another example, the weight percentage of the composite material in the membrane can range from about 1 wt. % to about 3 wt. %. In another example, the weight percentage of the composite material in the membrane can range from about 1.5 wt. % to about 2.5 wt. %. In one non-limiting example, the membranes of the present disclosure can include PLA and a nanocomposite including photocatalytic TiO₂/MWCNTs. The mixed matrix membrane can be present as one or more layers in contact with a support material. The support material can include a metal, a metal-containing compound, or a polymeric support.

In one example, the mean pore size of the membrane is greater than 45 nm. In another example, the mean pore size of the membrane is greater than 60 nm. In another example, the mean pore size of the membrane ranges from about 45 nm to about 200 nm. In another example, the mean pore size of the membrane ranges from about 50 nm to about 100 nm. In another example, the mean pore size of the membrane ranges from about 65 nm to about 85 nm. Utilizing nanomaterial of the present disclosure in polymeric membrane materials can increase the mean pore size of the membrane. Increasing the mean pore size of the membrane can increase the water permeation rate, improving efficiency. In one example, the porosity of the membrane is greater than about 60%. In another example, the porosity of the membrane is greater than 70%. In another example, the porosity of the membrane ranges from about 70% to about 85%. In another example, the porosity of the membrane ranges from about 75% to about 85%. In another example, the porosity of the membrane ranges from about 72% to about 83%. Porosity ranges of the present disclosure can promote enhanced permeability without sacrificing structural stability.

The membrane can exhibit hydrophilic properties sufficient to be a hydrophilic membrane. In oil-water separation applications, the hydrophilicity of the membranes can play a role in forming a hydration layer on the membrane surface through hydrogen and electrostatic bonding, which reduces fouling by repelling oil. For example, the membrane can exhibit a water contact angle (WCA) (e.g., static) of less than 90°. In another example, the membrane can exhibit a water contact angle (WCA) (e.g., static) of less than 85°. In another example, the membrane can exhibit a water contact angle (WCA) (e.g., static) of less than 80°. In another example, the membrane can exhibit a water contact angle (WCA) (e.g., static) ranging from 80° to 65°. In another example, the membrane can exhibit a water contact angle (WCA) (e.g., static) ranging from 80° to 70°. Water contact angles can be measured on a surface of the membrane, and water contact angles can be measured using a contact angle analyzer. Water contact angles of the present disclosure can be at least partially attributed to the enhancement of hydrophilicity by the addition of nanomaterial of the present disclosure. Enhancement of hydrophilicity can increase the water permeation rate and can reduce or prevent membrane fouling, such as fouling caused by oil.

In one example, due to the water-attracting properties of the hydrophilic membrane, hydrophilic membranes are less prone to fouling by oil or other hydrophobic compounds present in liquid streams (e.g., water-containing streams). This promotes stable performance and longer operational cycles. In terms of selectivity, hydrophilic membranes can be particularly efficient at separating oil from water due to the ability to repel oils while allowing water to pass through. The addition of the additive can enhance selectivity by fine-tuning pore sizes and surface properties, improving the selective rejection of oil droplets, suspended solids, and other organic contaminants in oily wastewater treatment. Enhanced selectivity can be important for producing high-purity effluent and compliance with environmental standards. In one non-limiting example and in contrast to hydrophobic membranes (e.g., surface static water contact angle >90°, hydrophobic membranes being prone to fouling and having lower water flux in oil-water filtration), the hydrophilic membranes of the present disclosure are less prone to fouling, improving the filtration efficiency.

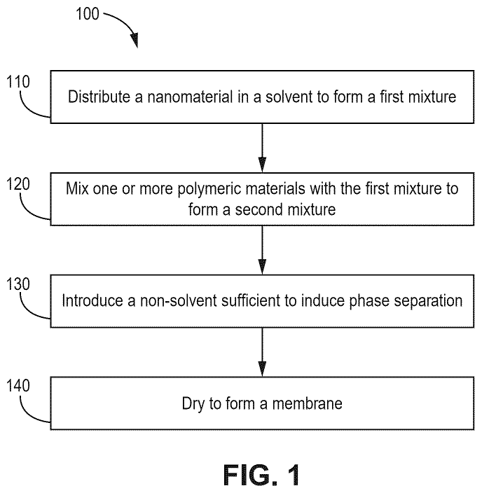

FIG. 1 illustrates a method for forming a membrane, according to some embodiments. A method 100 for forming a membrane includes one or more of the following steps (with various orders possible):

Referring to Step 110, a nanomaterial is distributed in a solvent to form a first mixture. Distributing can include mixing or otherwise contacting at least two components. The nanomaterial includes one or more additives/nanomaterials of the present disclosure. In one example, the solvent is a polar organic solvent. Examples of polar organic solvents include acetonitrile and Dimethylacetamide (DMAc). Distributing the nanomaterial in the solvent can include at least partially dissolving the nanomaterial in the solvent. In one example, distributing the nanomaterial in the solvent includes stirring and/or sonication to dissolve nanomaterial in the solvent. The first mixture can be in the form of a solution or suspension.

Referring to Step 120, one or more polymeric materials are mixed with the first mixture to form a second mixture. Mixing can include stirring, contacting, and/or heating at least two components. The one or more polymeric materials can include polymeric materials of the present disclosure. In one example, the one or more polymeric materials includes at least one of polylactic acid (PLA) and polyvinylpyrrolidone (PVP). During or after mixing, the second mixture can be subjected to heating. Heating can be sufficient to at least partially melt at least one of the polymeric materials, such as PLA. For example, the second mixture can be subjected to heating at a temperature ranging of greater than about 60° C. In one example, heating is applied for at least 1 hour, at least 2 hours, or at least 3 hours. Heating can promote substantially homogenous mixing.

The second mixture can be in the form of a solution or suspension. The formed second mixture can be stirred during various portions of the process, such as magnetically stirred. The resulting second mixture can be sonicated. For example, sonication can be performed for at least 30 minutes, at least 1 hour, or at least two hours. The resulting second mixture can be subjected to degasification before or after sonication. For example, degasification can be performed using a vacuum oven. Degasification can be performed at a temperature of greater than about 60° C. for at least 30 minutes, at least 1 hour, or at least 2 hours. Degasification can promote removal of trapped gases. After degasification, the at least partially degasified mixture can be called a dope solution.

In one example, the dope solution includes polylactic acid (PLA), where the weight percentage of PLA in the dope solution is greater than about 10 wt. %. In another example, the dope solution includes PLA, where the weight percentage of PLA in the dope solution ranges from about 10 wt. % to about 30 wt. %. In one example, the dope solution includes polyvinylpyrrolidone (PVP), where the weight percentage of PVP in the dope solution is greater than about 0.5 wt. %. In another example, the dope solution includes PVP, where the weight percentage of PVP in the dope solution ranges from about 1 wt. % to about 4 wt. %.

In one example, the dope solution includes nanomaterial, where the weight percentage of nanomaterial in the dope solution is greater than about 0.1 wt. %. Utilizing a weight percentage of nanomaterial greater than about 0.1 wt. % can promote desirable hydrophilicity and anti-fouling properties to the overall membrane. In another example, the dope solution includes nanomaterial, where the weight percentage of nanomaterial in the dope solution is greater than about 0.3 wt. %. In another example, the dope solution includes nanomaterial, where the weight percentage of nanomaterial in the dope solution ranges from about 0.1 wt. % to about 3 wt. %.

In another example, the dope solution includes nanomaterial, where the weight percentage of nanomaterial in the dope solution ranges from about 0.5 wt. % to about 2 wt. %. In another example, the dope solution includes nanomaterial, where the weight percentage of nanomaterial is less than 2 wt. %. In one non-limiting example, compared to using a dope solution having greater than 2 wt. % nanomaterial (which can cause pore blockage, decreasing permeation in liquid filtration applications), using a weight percentage of nanomaterial of less than 2 wt. % can promote efficient permeation and anti-fouling properties.

Method 100 may include casting. The formed mixture (such as in the form of a dope solution) can be casted using a casting knife on a substrate. In one example, the substrate can include at least one of glass and polyethylene. Referring to Step 130, a non-solvent is introduced sufficient to induce phase separation. Examples of non-solvents can include water, ethanol, chloroform, and ethyl acetate. In one example, the non-solvent is water. The non-solvent can be introduced by a water coagulation bath. The non-solvent can be used to at least partially remove or separate the solvent. For example, the non-solvent can be used to remove DMAC.

Referring to Step 140, drying is performed to form a membrane. After introducing the non-solvent to at least partially separate one or more components, drying can be performed to form the membrane. For example, drying can be performed at room temperature (e.g., about 20° C.) Drying can be performed for at least 1 hour, at least 5 hours, or at least 10 hours. The formed membrane can be hydrophilic. The formed membrane can include membranes of the present disclosure, such as membranes including f-MWCNT material that include at least one amide bond. In one example, the f-MWCNT material includes amino-SiO₂ functionalized MWCNTs.

In one non-limiting example, the membrane is formed by non-solvent induced phase separation using at least one of PLA (e.g., PLA pellets), N, N-Dimethylacetamide (DMAc), polyvinylpyrrolidone (PVP), 2-aminopropyl functionalized silica nanoparticles (e.g., <100 nm particle size), 1-ethyl-3-(3-dimethylaminopropyl) carbodiimide hydrochloride (EDC), N-hydroxysuccinimide (NHS), phosphate-buffer saline tablet (PBS), and Carboxylated MWCNTs (MWCNT-COOH). Functionalized, or nanocomposites including MWCNTs can be formed prior to mixing with PLA.

The present disclosure includes filtration systems and methods. In one example, filtration includes fluid filtration, such as liquid (e.g., water) filtration. For example, membranes of the present disclosure can be used as a nanofiltration membrane, an ultrafiltration membrane, or a microfiltration membrane. In one example, the membrane is an ultrafiltration membrane. An ultrafiltration membrane can have a mean pore size ranging from about 0.001 μm (1 nm) to about 0.1 μm (1000 nm).

In one example, the mean pore size of the membrane is greater than 45 nm. In another example, the mean pore size of the membrane is greater than 60 nm. In another example, the mean pore size of the membrane ranges from about 45 nm to about 200 nm. In another example, the mean pore size of the membrane ranges from about 50 nm to about 100 nm. In another example, the mean pore size of the membrane ranges from about 65 nm to about 85 nm. Tuned pore sizes can promote efficient filtration of liquids, without substantially sacrificing liquid flux. The membrane can be prepared with various thicknesses. In one example, the membrane has a thickness ranging from about 20 μm to about 500 μm. In one example, the membrane has a thickness ranging from about 100 μm to about 300 μm.

Membranes of the present disclosure can be used for filtering liquid(s). In one example, the liquid includes water. In another example, the liquid includes at least water and oil. The liquid(s) can be contacted with the membrane sufficient to form a permeate stream, where the permeate stream includes water. Oil can include one or more liquid fats derived from plant or animal sources. For example, oil can include triglycerides. Oil can include one or more petroleum-based oils. Generally, petroleum-based oils include hydrocarbons. Oil can include synthetic oils. Many industrial sectors produce hazardous oily effluent, including crude oil extraction, oil refinement, lubricant manufacture, metalworking, and vehicle cleaning. Membrane technology has distinctive advantages compared to alternatives, such as high separation efficiency, low footprint, ease of operation, and smooth integrability. While conventional membranes are subject to membrane fouling, membranes of the present disclosure exhibit advanced properties for reduced membrane fouling in liquid treatment systems.

The feed liquids to be filtered can include a mixture including water and oil. The mixture including water and oil can be in the form of an oil-water emulsion. In one example, a concentration of oil in the oil-water emulsion can range from about 100 mg/L to about 4000 mg/L. In another example, a concentration of oil in the oil-water emulsion can range from about 250 mg/L to about 2000 mg/L. In another example, a concentration of oil in the oil-water emulsion can range from about 500 mg/L to about 1500 mg/L. The oil-water emulsion can exhibit an average droplet size ranging from about 100 nm to about 500 nm. The membrane can exhibit a permeation of liquid therethrough of greater than 100 LMH/bar (liters per square meter per hour/bar). The membrane can exhibit a permeation of liquid (e.g., from an oil-water emulsion) therethrough of greater than 200 LMH/bar. The membrane can exhibit a permeation of liquid therethrough of greater than 250 LMH/bar. The membrane can exhibit a permeation of liquid (e.g., pure water) therethrough of greater than 400 LMH/bar.

The membrane can exhibit an oil rejection percentage of greater than 98% when filtering a feed liquid including oil and water. The membrane can exhibit an oil rejection percentage of greater than 99% when filtering a feed liquid including oil and water. In one non-limiting example, the incorporation of super hydrophilic amino-SiO₂ within the mixed matrix solution of MWCNTs-COOH in the membrane resulted in the formation of additional nanochannels within the membrane's mixed matrix. This feature promotes the improvement in water permeability, as well as enhanced oil rejection capabilities of the membrane. Further, the membranes of the present disclosure reduce or prevent fouling. Membrane filtration performance can be at least partially dependent on overcoming oil fouling, which affects water permeability, efficiency, membrane lifespan, and/or operating expenses. Addressing fouling improves membrane filtration's viability and contributes to efficient oily wastewater purification.

Accordingly, membranes and filtration methods of the present disclosure can be used for fluid filtration (e.g., water filtration). The incorporation of an additive dispersed in the polymer matrix can promote membrane hydrophilicity. The hydrophilicity of the membranes can play a role in forming a hydration layer on the membrane surface through hydrogen and electrostatic bonding, which reduces fouling by repelling oil. Reducing or preventing fouling improves overall filtration efficiency by improving or maintaining the permeation flux over a longer period of time. Further, the membrane can be formed using green polymeric materials, such as materials from non-toxic renewable resources.

### Example 1

PLA pellets (Mw: 242,000 g/mol), N, N-Dimethylacetamide (DMAc, Mw: 87.12 g/mol, purity ≥99%), polyvinylpyrrolidone (PVP, Mw: 40,000 g/mol), 2-aminopropyl functionalized silica nanoparticles (<100 om particle size), 1-ethyl-3-(3-dimethylaminopropyl) carbodiimide hydrochloride (EDC, Mw: 191.7 g/mol). N-hydroxysuccinimide (NHS, purity ≥98%), phosphate-buffer saline tablet (PBS), Carboxylated MWCNTs (MWCNT-COOH) (+98% pure), commercial canola oil, and deionized (DI) water were utilized.

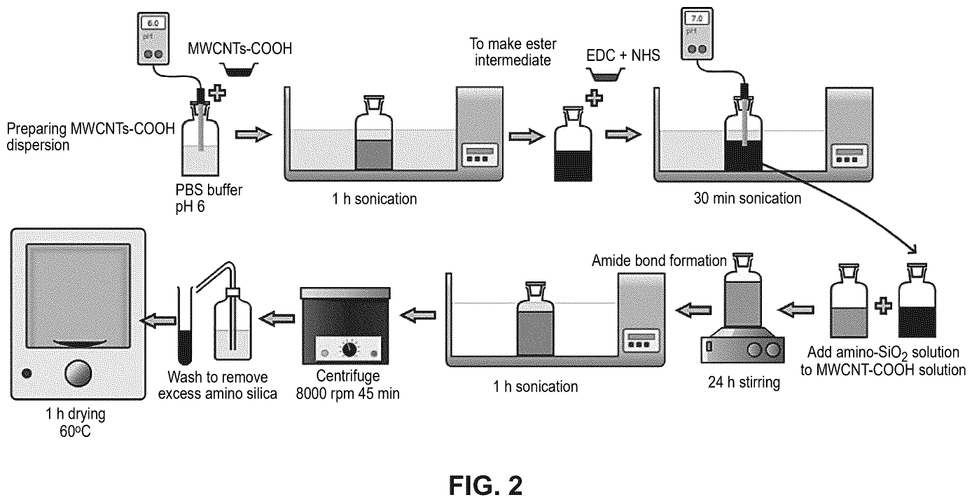

FIG. 2 illustrates an example process for forming nanomaterial, according to some embodiments. To prepare amino-SiO₂ functionalized MWCNTs (f-MWCNTs), 0.5 mg/mL of MWCNTs-COOH were dissolved in 10 mM PBS buffer (pH 6), sonicated for 30 minutes, and then added as crosslinkers to produce an ester intermediate with 2 mM of EDC and 5 mM of NHS. The mixture was then calibrated to a pH of 7 and sonicated for 30 minutes. A 1 mg/ml, amino-SiO₂ solution was made and sonicated for 30 minutes (pH 5) in a different flask. Using a magnetic stirrer, the amino-SiO₂ and MWCNTs-COOH solutions were blended for 24 hours before being sonicated for 1 hour to create a strong amide bond. The solution was then centrifuged for 45 minutes at 8000 rpm. The nanomaterial was then washed several times with DI water to remove excess and unreacted amino silica and then dried at 60° C. for 1 hour.

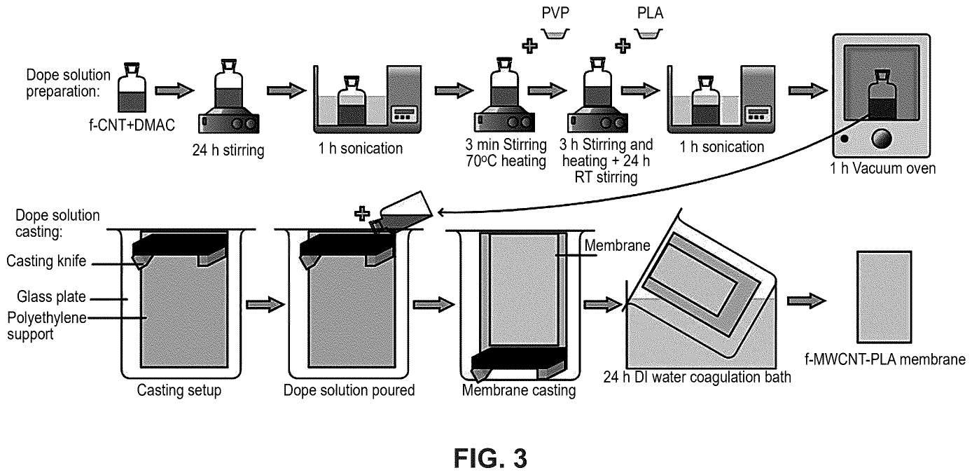

FIG. 3 illustrates an example process for forming a membrane, according to some embodiments. Pristine PLA and PLA/f-MWCNTs membranes were prepared. Initially, f-MWCNTs nanomaterial was subjected to stirring and sonication with DMAc overnight to allow particles to dissolve and distribute in the solvent. Subsequently, PLA and PVP were introduced to the solvent and subjected to heating at 70° C. for a duration of 2 hours, this step ensured melting of PLA and homogenous mixing. The polymer solutions were then magnetically stirred for 24 hours to ensure uniformity of the solution. The resulting solutions were then further sonicated for 1 hour and subjected to degasification at 70° C. in a vacuum oven for 1 hour to remove any trapped gases.

To cast the membranes, the solutions were casted using a casting knife with a height gap of 250 μm onto clean glass plates supported by polyethylene. To remove remaining PVP and DMAC, the glass plates were submerged in a DI water coagulation bath for 24 hours and then washed three times with DI water. The fabricated membranes (PLA, PLA/MWCNTs, PLA/f-MWCNTs 0.5, PLA/f-MWCNTs 1, and PLA/f-MWCNTs 2) were dried at room temperature for 24 hours. Weight % loadings of PLA polymer and f-MWCNTs nanomaterial are listed in Table 1.

TABLE 1
Dope solution components of fabricated membranes.

| | | | MWCNTs- | |
|---|---|---|---|---|
| | PLA | PVP | COOH | f-MWCNTs |
| Membrane | (wt. %) | (wt. %) | (wt. %) | (wt. %) |
| PLA | 18 | 2 | 0 | 0 |
| PLA/MWCNTs | 18 | 2 | 0.5 | 0 |
| PLA/f-MWCNTs 0.5 | 18 | 2 | 0 | 0.5 |
| PLA/f-MWCNTs 1 | 18 | 2 | 0 | 1 |
| PLA/f-MWCNTs 2 | 18 | 2 | 0 | 2 |

The morphological and structural properties of PLA membranes were examined using scanning electron microscopy on both the surface and cross-section of the samples. To produce high-quality images and avoid charging effects during the analysis, a 10 nm gold-palladium layer was applied to all membrane samples. Cross-sectional samples were fractured using liquid nitrogen and attached to the SEM holder. The chemical structure of the membranes was also analyzed using Fourier transform infrared (FT-IR) spectroscopy equipped with an attenuated total reflectance (ATR) accessory. The functional groups of the prepared membranes were analyzed by scanning the samples 64 times with a resolution of 4 cm⁻¹.

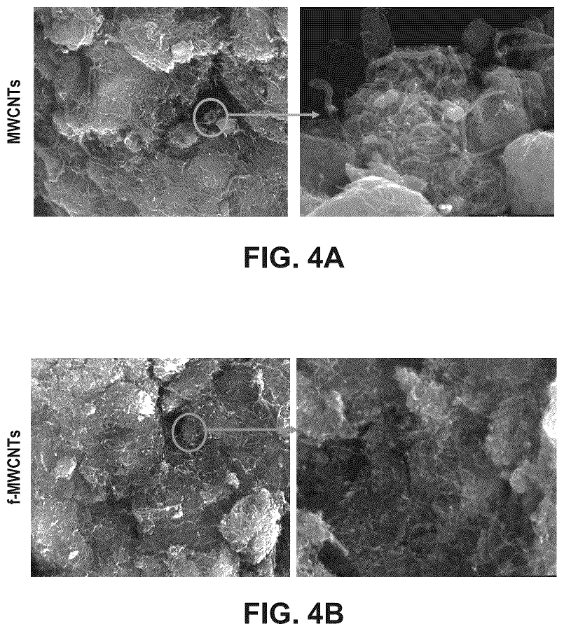

FIG. 4A illustrates scanning electron microscope (SEM) images of multi-walled carbon nanotubes (MWCNTs) at different magnifications, according to some embodiments. FIG. 4B illustrates SEM images of functionalized multi-walled carbon nanotubes (f-MWCNTs) at different magnifications, according to some embodiments. Initially, the surface of the MWCNTs was visibly smooth and the MWCNT's intertwined. However, when amino-SiO₂ was introduced to MWCNTs, the structure exhibits a bundle of coarse tubes with the amino-SiO₂ densely packed on the top surface of MWCNTs in high-magnification SEM images. This illustrates that the amino-SiO₂ nanoparticles were successfully grafted onto the MWCNTs-COOH. The amino-SiO₂ loading into MWCNTs surface generated enhanced surface roughness and external diameter compared to unfunctionalized MWCNTs.

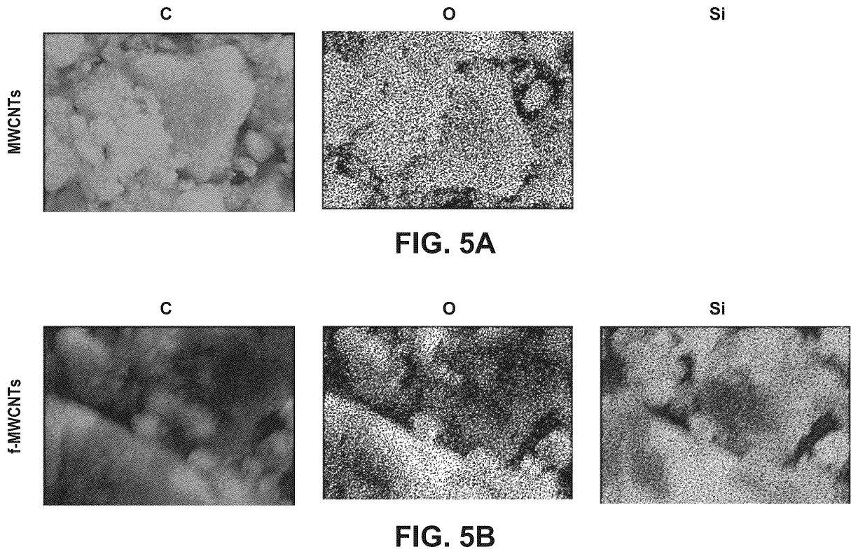

FIG. 5A illustrates energy dispersive X-ray spectroscopy (EDS) mapping of MWCNT nanomaterial, according to some embodiments. FIG. 5B illustrates EDS mapping of f-MWCNT nanomaterial, according to some embodiments. To confirm the presence of amino-SiO₂ in the f-MWCNTs, EDS elemental scanning and mapping were carried out on both the functionalized and unfunctionalized MWCNTs. The EDS mapping involved the detection and analysis of carbon (C), oxygen (O), and silicon (Si) elements. The main component observed in the MWCNTs was C, with the other elements being evenly distributed around it. Upon functionalization of the MWCNTs (i.e. f-MWCNTs), a decrease in the C content was observed, while Si and O contents showed significant increases. This indicates the absence or minimal presence of Si in the unfunctionalized MWCNTs, whereas in the f-MWCNTs, Si constituted approximately 15% of the nanoparticle weight.

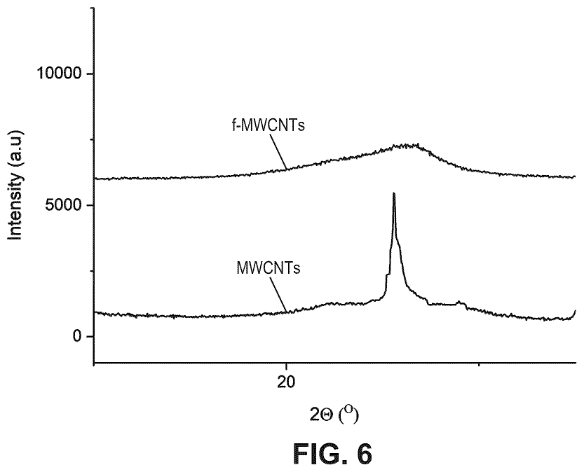

FIG. 6 illustrates X-ray Diffraction (XRD) analysis of MWCNT and f-MWCNT nanomaterial, according to some embodiments. X-ray diffraction (XRD) analysis (40 kV and 35 mA) was performed to determine the chemical composition and crystallinity of the membranes. Typically, pristine MWCNTs exhibit a characteristic diffraction peak at 26° 2θ, corresponding to the reflections of a hexagonal graphite structure. This distinctive peak shows the presence of the hexagonal graphite structure. In contrast, the f-MWCNTs exhibited a noticeably broader and lower peak intensity, which can be attributed to the semicrystalline nature resulting from the grafting of amino-SiO₂. This increased heterogeneity in the structure suggests successful functionalization. On the other hand, the MWCNTs displayed a sharp peak, indicating their crystalline structure.

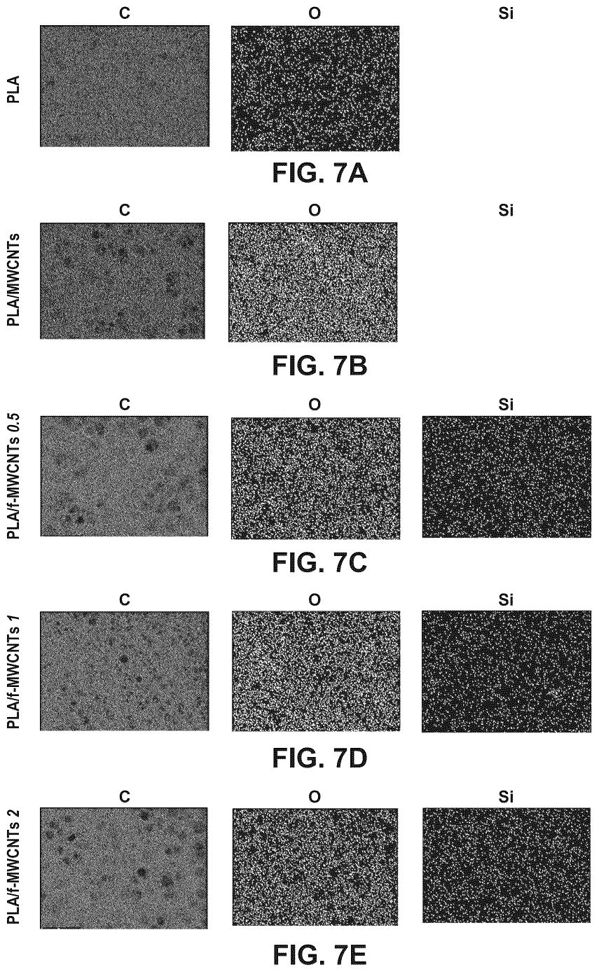

FIG. 7A illustrates EDS surface elemental mapping of a fabricated membrane, according to some embodiments. Specifically, FIG. 7A illustrates EDS surface elemental mapping of the PLA membrane. FIG. 7B illustrates EDS surface elemental mapping of a fabricated membrane, according to some embodiments. Specifically, FIG. 7B illustrates EDS surface elemental mapping of the PLA/MWCNTs membrane. FIG. 7C illustrates EDS surface elemental mapping of a fabricated membrane, according to some embodiments. Specifically, FIG. 7C illustrates EDS surface elemental mapping of the PLA/f-MWCNTs 0.5 membrane. FIG. 7D illustrates EDS surface elemental mapping of a fabricated membrane, according to some embodiments. Specifically, FIG. 7D illustrates EDS surface elemental mapping of the PLA/f-MWCNTs 1 membrane. FIG. 7E illustrates EDS surface elemental mapping of a fabricated membrane, according to some embodiments. Specifically, FIG. 7E illustrates EDS surface elemental mapping of the PLA/f-MWCNTs 2 membrane.

It is shown that the nanoparticles did not aggregate on the surface of the membrane, resulting in a smooth membrane without any visible defects. The successful integration of the nanoparticles into the membrane is further supported by FIGS. 7C-7E, demonstrating that as the loading and distribution of f-MWCNTs within the PLA membrane increased, the distribution of silica also increased, as verified by the percentage composition obtained from EDS elemental analysis. For MWCNTs, the elemental distribution (wt. %) is —C; 90.41, O; 8.82, and Si; 0.77. For f-MWCNTs, the elemental distribution (wt. %) is —C; 69.13, O; 15.2, and Si; 15.67.

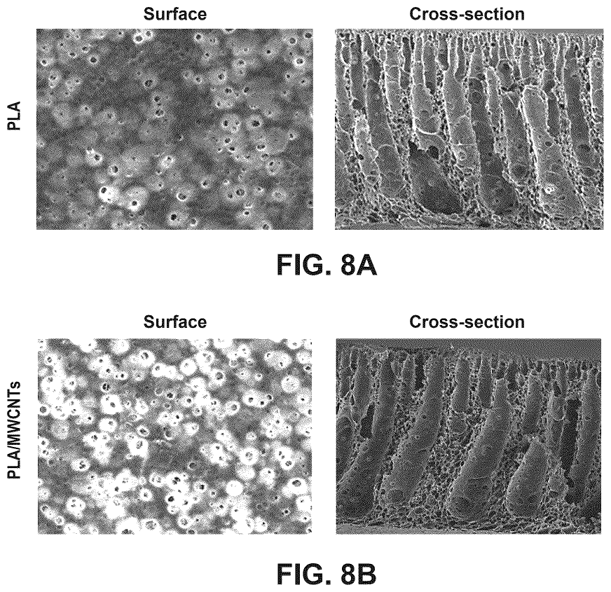

FIG. 8A illustrates SEM images of a membrane at the surface and cross-section, according to some embodiments. Specifically, FIG. 8A illustrates SEM images of the surface and cross-section of the PLA membrane. FIG. 8B illustrates SEM images of a membrane at the surface and cross-section, according to some embodiments. Specifically. FIG. 8B illustrates SEM images of the surface and cross-section of the PLA/MWCNTs membrane.

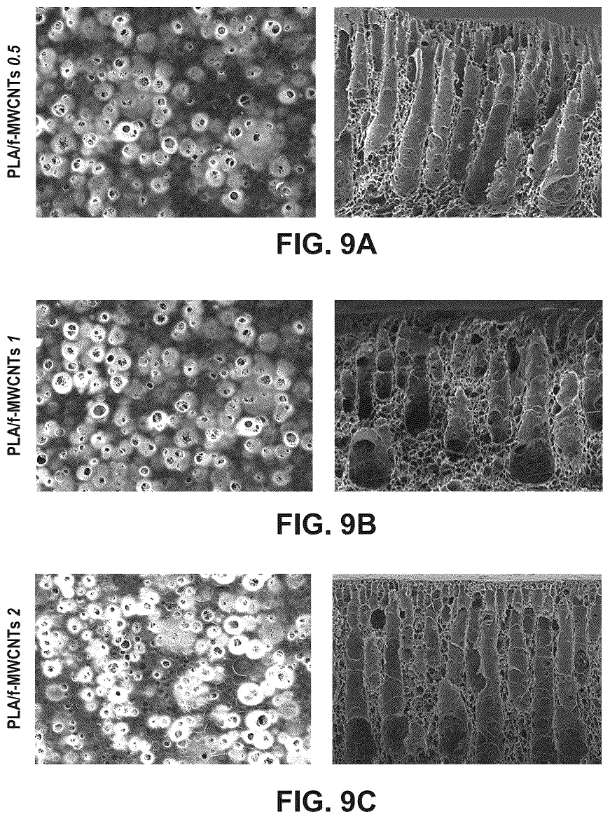

FIG. 9A illustrates SEM images of a membrane at the surface and cross-section, according to some embodiments. Specifically, FIG. 9A illustrates SEM images of the surface and cross-section of the PLA/f-MWCNTs 0.5 membrane. FIG. 9B illustrates SEM images of a membrane at the surface and cross-section, according to some embodiments. Specifically, FIG. 9B illustrates SEM images of the surface and cross-section of the PLA/f-MWCNTs 1 membrane. FIG. 9C illustrates SEM images of a membrane at the surface and cross-section, according to some embodiments. Specifically, FIG. 9C illustrates SEM images of the surface and cross-section of the PLA/f-MWCNTs 2 membrane.

For example, as the f-MWCNTs loading increased, the pore size and density of the membranes increased. This is due to the compatibility of the hydrophilic filler and hydrophobic polymer, which can cause the nanoparticles to slightly aggregate and result in poor interface compatibility with nonpolar PLA. Additionally, as nanoparticle loadings increase, the viscosity of the dope solution increases, which delays the exchange rate of solvent and nonsolvent, increasing pore size.

The cross-sectional images presented in FIGS. 8A-8B and FIGS. 9A-9C demonstrated an asymmetric structure including a porous lower layer and a thin, dense upper layer, resulting in a finger-like appearance. This morphology arises from the solubility of PVP in water and its subsequent removal from the polymer matrix during the phase inversion process. In the top layer of the membrane, the initial PLA membrane exhibited the smallest pore size, which gradually increased with higher loadings. Moreover, the incorporation of f-MWCNTs at increased loadings resulted in the enlargement of the finger-like pores in the membrane. The observed effect can be attributed to the interplay of kinetic and thermodynamic factors during the exchange of solvents and non-solvents in the phase inversion process.

The hydrophilicity of the membranes was evaluated using the contact angle method with a contact angle analyzer. The membranes were cut into small pieces, fixed onto a glass plate, and 5 μL of DI water was dropped onto the membrane. The porosity of the membranes was measured using the dry-wet method, where the weight of the membrane samples was recorded before and after immersion in Galwick solution, W_{d} and W_{w}; respectively for 24 hours. The porosity was calculated using Equation 1.

$$ε ( \% ) = \frac{{W}_{W} - {W}_{d}}{A \times {ρ}_{G} \times δ} * 100 \% \qquad ( 1 )$$

where ρ_{G} is the Galwich solution density, A is the effective membrane area, and o is the membrane thickness. The average pore radius was calculated using the Guerout-Elford-Ferry equation shown as Equation 2.

$${r}_{n} = \sqrt{\frac{( 2.9 - 1.75 ε ) \times 8 ηδ Q}{ε A Δ P}} \qquad ( 2 )$$

where η is the water viscosity, ΔP is the operational pressure, and Q is the water flux.

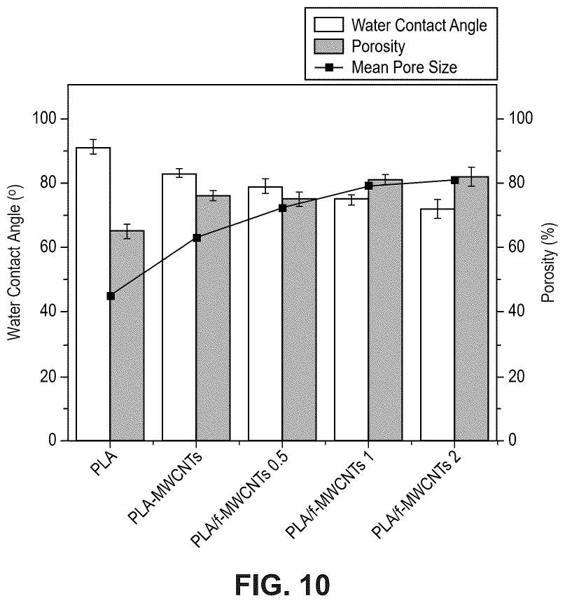

FIG. 10 illustrates porosity, mean pore size, and water contact angle (e.g. static) of membranes, according to some embodiments. The results demonstrated an increase in hydrophilicity as f-MWCNT loading increased, from 91° for the pristine PLA membrane to 72° for the PLA/f-MWCNTs 2 membrane. This effect can be attributed to the hydrophilicity of amino-SiO₂, which enhances its ability to attract water molecules more effectively. In contrast, the membrane porosity increased from approximately 65% to 82% (from the pristine PLA to PLA/f-MWCNTs 2 membranes). This can be attributed to the interactions between the hydrophilic filler and hydrophobic polymer during the phase inversion process, as well as the rate of solvent exchange in the coagulation bath. Furthermore, the average pore size of the pristine PLA membrane was 45 nm, with the larger average pore size observed in the PLA/f-MWCNTs 2 membrane, measuring 81 nm.

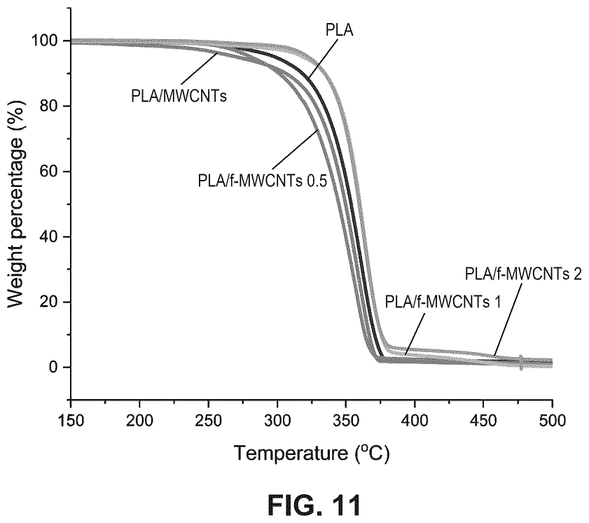

FIG. 11 illustrates thermogravimetric analysis (TGA) profiles for various membranes, according to some embodiments. The thermal degradation properties of the membranes were evaluated using a thermogravimetric analyzer (TGA) by measuring weight loss from 25° C. to 800° C., with a heating rate of 10° C./minute. The samples were loaded into a platinum sample holding pan to gradually increase the temperature up to 800° C. The pure PLA membranes exhibit a thermal decomposition temperature of approximately 312° C., characterized by a single decomposition stage. Analysis of the Tₒₙₛₑₜ values for all the samples reveals that the functionalized membranes had similar values to the pure PLA membrane. This is due to the combined thermal gravimetric decomposition temperature of SiO₂/MWCNTs reported at 250 and 300° C. and the low loadings of the NPs, which explains the low effect on the membrane's degradation. Nonetheless, the membranes with higher f-MWCNT's loadings (1 and 2 wt. %) exhibit improved thermal stability, with a temperature of 325° C. The modified membranes exhibited good thermal stability and can be safely operated at temperatures below 300° C. In on example, the PLA/MWCNTs and PLA/f-MWCNTs 0.5 membranes exhibited lower thermal decomposition temperatures. This can be attributed to the reduced crystallinity of PLA within the membranes.

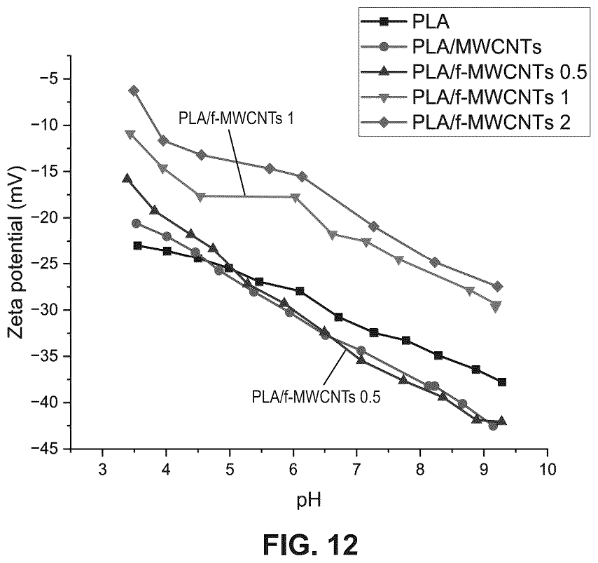

FIG. 12 illustrates zeta potential for various membranes, according to some embodiments. Zeta potential measurements were performed to elucidate how different forms of functionalization can affect oil-water separation. The zeta potential can be highly dependent on the conditions of the surrounding solution, such as pH, ionic strength, and the presence of other ions. Changes in these solution conditions can alter the surface charge and, consequently, the zeta potential. When comparing the PLA/MWCNTs membrane to the PLA/f-MWCNTs membrane, the functional groups on the nanomaterial altered the zeta potentials. Because of the presence of the amine group, the zeta potentials of all PLA/f-MWCNTs decreased as nanoparticle loadings increased. In one example, amino-silica nanoparticles can exhibit a positive zeta potential at acidic pH, as the amino groups on the particle surface become protonated.

However, in the case of functionalized amino-silica nanoparticles with negative MWCNTs, the interaction with the positive amino groups and negative CNTs and PLA resulted in membranes possessing a net negative electric charge. This phenomenon arises from the combined effects of the surface charges of the constituent materials within the membranes. In one example, at lower loadings such as PLA/f-MWCNTs 0.5 and PLA/MWCNTs, the originally neutral pristine PLA membrane exhibited a shift towards a more negative charge, particularly at highly acidic and basic pH levels exceeding 5. This shift can be attributed to the presence of silanol hydroxyl groups, which can undergo deprotonation and contribute to the generation of a negative charge. Additionally, the presence of amine groups with lone pairs of electrons can also contribute to the overall negative charge of the membrane.

Membrane performance was determined based on the oil-water emulsion separation permeation and rejection using dead-end ultrafiltration (UF) setup. The ultrafiltration of oil emulsions can differ qualitatively from other colloidal suspensions. This distinction arises due to the variable sizes of oil droplets, which are influenced by factors such as shear force, concentration, oil-surfactant ratio, and interactions with the membrane. An oil-water emulsion of 1000 mg/L oil concentration and a droplet size range of 100-500 nm was prepared by dissolving 1 g commercial canola oil in 1 L DI water and was used as a model feed to evaluate the performance of the membranes. To obtain a stable and homogenous oil-in-water emulsion, the mixture was sonicated for 3 hours and stirred at 200 rpm for 3 hours.

For the membrane performance testing, initially, membrane compaction was completed using DI water for 30 minutes at 30 psi followed by constant volume water permeation test at 20 psi. Similarly, an oil-water emulsion was passed through compressed membranes at 20 psi and constant volume. Permeation Pm measurements of the membranes were calculated using Equation 3.

$$Pm = \frac{V}{A \times t \times P} \qquad ( 3 )$$

where t is the time, Vis the filtered water or emulsion volume, A is the membrane's area and P is the applied pressure. The rejection efficiency R (%) was calculated using Equation 4.

$$R ( \% ) = \frac{1 - {C}_{E}}{{C}_{F}} \qquad ( 4 )$$

where C_{E} and C_{F} are the oil concentrations in the emulsion and filtrate (ppm); respectively. Each experiment was repeated 3 times. The oil concentration was measured from a pre-prepared standard oil concentration calibration curve using a UV spectrophotometer.

A three-cycle fouling evaluation was conducted to assess the performance of the membranes. Each cycle included several steps. Firstly, the initial pure water flux (Jw) of the membrane was measured using DI water at a pressure of 20 psi for a duration of 30 minutes. Following this, the emulsion was introduced as the feed and a filtration test was performed with stirring at 20 psi for 1 hour. The permeate flux (J_{f}) of the membrane during the filtration process was recorded. To evaluate the recovery of flux after the filtration of the emulsion, backwashing was performed, and the pure water flux (J_{w2}) of the cleaned membrane was measured again with DI water for 30 min. The last step of each cycle served as the first step of the subsequent cycle. The fouling indicators, including the water flux recovery ratio (Fᵣᵣ), the total fouling ratio (Rₜ), the reversible fouling ratio (Rᵣ), and the irreversible fouling ratio (Rᵢᵣ), were estimated using Equations 5-8.

$${F}_{rr} = \frac{{J}_{w 2}}{{J}_{w 1}} \times 100 \% \qquad ( 5 )$$

$${R}_{t} = \frac{{J}_{w 1} - {J}_{f}}{{J}_{w 1}} \times 100 \% \qquad ( 6 )$$

$${R}_{r} = \frac{{J}_{w 2} - {J}_{f}}{{J}_{w 1}} \times 100 \% \qquad ( 7 )$$

$${R}_{ir} = \frac{{J}_{w 1} - {J}_{w 2}}{{J}_{w 1}} \times 100 \% \qquad ( 8 )$$

where J_{w1} and J_{w2} are the pure water flux of the fresh membrane and used membrane (after cleaning); respectively.

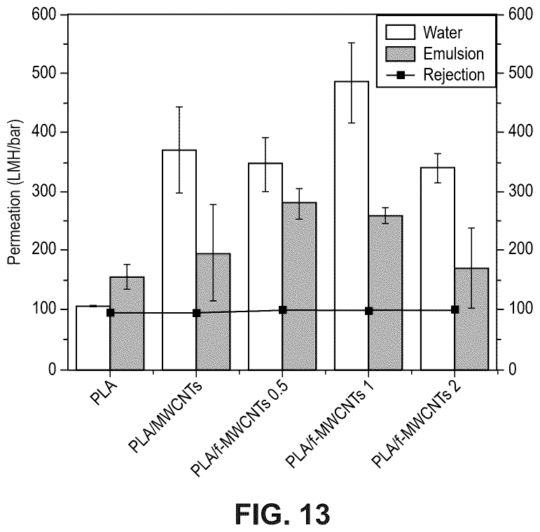

FIG. 13 illustrates membrane performance profiles including water and emulsion permeation flux, and oil rejection, according to some embodiments. The performance of the prepared ultrafiltration (UF) membranes were tested using DI water and synthetic oil-water emulsion. The incorporation of MWCNTs into PLA membranes led to an increase in water permeation compared to the pristine membrane. The water permeation rate reached a value of 485 LMH/bar at a loading of 1 wt. % f-MWCNTs. This increased permeability can be attributed to two factors: the enlargement of pore size and the enhancement of hydrophilicity. In one non-limiting example, one important factor is the increased pore size, as evident from the PLA/MWCNTs membranes that exhibited less than a 10° difference in water contact angle (WCA) compared to the pristine membrane, but still experienced a significant increase in permeation. In one non-limiting example, at a higher loading of 2 wt. % f-MWCNTs, the permeation rate dropped to 370 LMH/bar, which can be due to pore clogging by the oil droplets. Since pore size increased with increased loadings, oil droplets can settle on (and in) the pores easier than with smaller pores—hence the permeation can decrease.

In contrast, when the synthetic oil-water emulsion was tested, all membranes exhibited lower permeability compared to pure DI water. This reduction in permeability can be attributed to the initial deposition and coalescence of oil droplets on and within the membrane's surface, leading to partial pore blocking. However, when compared to the pristine membrane, the permeability of the PLA/f-MWCNTs membranes showed significant improvement. Specifically, the permeation rates increased from 155 LMH/bar for the pristine membrane to 281 LMH/bar for PLA/f-MWCNTs 0.5 and 260 LMH/bar for PLA/f-MWCNTs 1.

Oil rejections of 94.9±0.1, 95.1±0.2, 100±0.1, 98.9±0.3, and 99.2±0.1% were obtained for PLA, PLA/MWCNT, PLA/f-MWCNTs 0.5, PLA/f-MWCNTs 1, and PLA/f-MWCNTs 2; respectively. Both the flux and oil rejection of the prepared membranes were enhanced through blending PLA with f-MWCNTs. The incorporation of super hydrophilic amino-SiO₂ within the mixed matrix solution of MWCNTs-COOH in the membrane resulted in the formation of additional nanochannels within the membrane's mixed matrix. This unique feature contributed to the improvement in water permeability, as well as enhanced oil rejection capabilities of the membrane. The presence of these extra nanochannels facilitated the efficient transport of water molecules through the membrane, while effectively rejecting oil molecules, thus enhancing the overall performance of the membrane. In one example, increasing the loading of nanomaterial also led to an increase in the number of pores within the membrane. As a result, the oil rejection performance of the membranes was excellent at a loading of 0.5 wt. % nanomaterial.

However, as the loading further increased to 1 wt. % and 2 wt. %, the oil rejection capability began to decrease. This can be attributed to the size exclusion mechanism, where larger pores allow oil particles to pass through the membrane. When comparing the PLA and PLA/f-MWCNTs membranes, it was observed that the latter exhibited significant improvements in both permeability and oil rejection at a loading of 0.5 wt. % nanomaterial. This shows that the incorporation of MWCNTs into the PLA membrane was effective in enhancing the membrane's performance and is also economically advantageous.

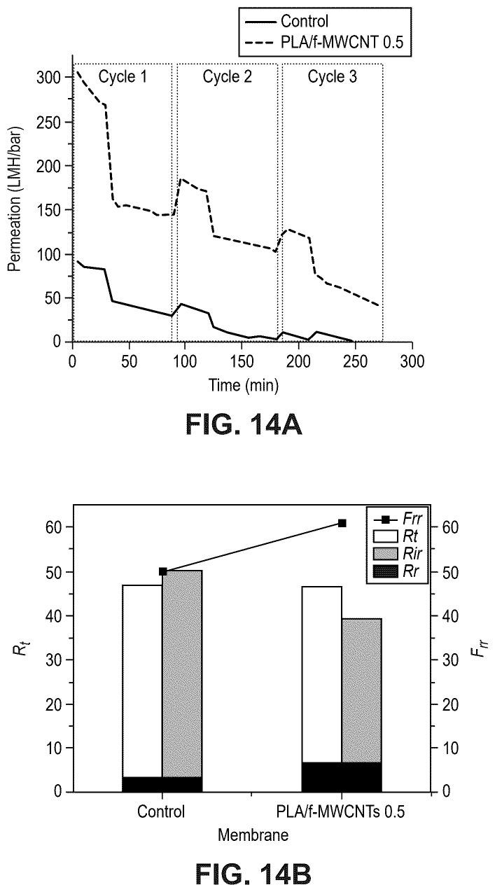

FIG. 14A illustrates 3-cycle filtration of oil-water emulsion, according to some embodiments. Cyclic permeation testing was performed on the fabricated membranes to assess their filtration efficiency and dynamic fouling resistance. The main reasons behind fouling are either pore clogging by foulants or their adsorption on the surface of membranes, which can cause reversible or irreversible fouling. FIG. 14B illustrates flux recovery ratio (Fᵣᵣ), total fouling ratio (Rₜ), reversible fouling ratio (Rᵣ), and irreversible fouling ratio (Rᵢᵣ) of the 1st cycle, according to some embodiments. FIG. 14B illustrates the calculated fouling indicators, with the first cycle serving as the basis for the calculations. Results illustrated a reduction of permeability when oil-water emulsion was used as feed instead of DI water. This is due to the adsorption of oil on the surface and in the pores of the membranes. Furthermore, it was observed that both membranes, namely PLA and PLA/f-MWCNTs 0.5, experienced some fouling. This can be attributed to the hydrophilic nature of the membranes, as indicated by their contact angle measurements of 90° for PLA and 79° for PLA/f-MWCNTs 0.5. The attraction of oil to the membrane surface can lead to the accumulation of oil droplets, contributing to pore blockage.

In the comparison between the two membranes, it was observed that after three cycles, the pristine membrane underwent complete blockage, resulting in near-zero permeability. In contrast, the PLA/f-MWCNTs 0.5 membrane continued to filter the emulsion, although at a reduced penetration rate compared to before. The improved performance of the PLA/f-MWCNTs 0.5 membrane can be attributed primarily to its improved hydrophilicity, which effectively repelled oil and facilitated the removal of some oil droplets from the pores during backwashing. This reduced the extent of pore blockage and contributed to the membrane's ability to maintain some level of filtration even after multiple cycles. The PLA/f-MWCNTs 0.5 membrane exhibited a flux recovery of 60% of the initial value after a simple DI water wash between two filtration cycles, while the pristine PLA membrane only achieved a flux recovery of 49%.

After two complete cycles, the flux recovery for PLA/f-MWCNTs 0.5 reached approximately 42%, whereas the pristine PLA membrane exhibited only 11% recovery compared to the original permeation. When the oil rejection was measured for these samples, which underwent a total of 275 min of cyclic filtration, the PLA/f-MWCNTs 0.5 showed consistent oil removal efficiency of 99.9% after two filtration cycles, whereas that of the pristine membrane was 94.1%. These improvements can be attributed to the increased porosity and improved hydrophilicity of the functionalized membranes. The higher pore count in the functionalized membranes delays complete pore clogging, allowing for longer permeation. Additionally, the hydrophilicity of the membranes can play a role in forming a hydration layer on the membrane surface through hydrogen and electrostatic bonding, which reduces fouling by repelling oil. Comparative analysis with other membranes for oil-water separation applications shows that the fabricated PLA/f-MWCNTs membranes demonstrate superior oil rejection and permeation flux, as summarized in Table 2.

TABLE 2
Membrane Comparison.

| | Emulsion | Pristine | Functionalized | Emulsion | |
|---|---|---|---|---|---|
| | concentration | membrane | membrane | permeation | Rejection |
| Membrane | (mg/L) | WCA (°) | WCA (°) | (LMH/bar) | (%) |
| PES/SiO₂ | 2000 | 81 | 62 | 291 | 98 |
| PVDF/PEGMA- | N/A | 68.7 | 50.7 | 40 | 95 |
| SiO₂ | | | | | |
| PES/APTES- | 250 | 74.9 | 56.5 | 112 | 98.79 |
| SiO₂ | | | | | |
| PLA/Amino- | 1000 | 90 | 70 | 281 | ~100 |
| SiO₂- | | | | | |
| MWCNTs | | | | | |

WCA: water contact angle, PES: poly(ether-sulfone), PVDF: polyvinylidene fluoride, PEGMA; poly (ethylene glycol) methacrylate.

The hydrophobic nature of PLA can be improved by functionalization using hydrophilic nanomaterial. Specifically, the hydrophilicity of the PLA membrane was increased by 20° through the addition of hydrophilic amino-SiO₂-MWCNTs, resulting in PLA/f-MWCNTs 2 membranes. Along with hydrophilicity enhancement, these functionalized membranes improved the emulsion permeability, reaching up to 281 LMH/bar for PLA/f-MWCNTs 0.5 compared to 155 LMH/bar.

Furthermore, PLA/f-MWCNTs 0.5 membranes showed greatly enhanced antifouling properties over the pristine membrane. Unlike the pristine membrane, which experienced almost complete blockage of pores due to oil droplet deposition and adhesion even after backwashing, the functionalized membrane exhibited sustained permeation even after three cycles of filtration to about 50 LMH/bar. This improvement can be attributed to the altered surface properties and enhanced hydrophilicity of the functionalized membrane, which effectively repelled oil droplets and prevented their attachment and pore clogging. Despite the lower loading of 0.5 wt. % of nanomaterial, the PLA/f-MWCNTs 0.5 membrane exhibited significant enhancements, making it a cost-effective solution for achieving desirable membrane characteristics. In one example, a minimal nanoparticle loading can be utilized to achieve substantial improvements in membrane performance, thereby offering economic advantages in practical applications.

### Example 2

TiO₂ functionalized multi-walled carbon nanotubes were synthesized as follows: 5 g of MWCNTs-COOH were mixed with 80 mL of DI water and stirred at a speed of 200 rpm for 10 minutes. 1 g of TiO₂ (rutile) was dissolved in 20 mL of DI water and agitated at a speed of 200 rpm for 10 minutes. Both liquids were combined and agitated for 30 minutes at room temperature (e.g., 20° C.), followed by 2 hours of sonication. Subsequently, the mixture was transferred to a round bottom flask and subjected to ongoing agitation and heating at a temperature of 80° C. in an oil bath. The mixture was then concentrated through the process of H₂O evaporation. The TiO₂ nanoparticles can chemically adsorb onto the carboxylic acid of the MWCNTs because of robust contacts. TiO₂ can cling to MWCNTs in regions lacking COOH through electrostatic adsorption, which occurs when the titanium ion and the surface electric charge of the MWCNTs attract each other. The composite was subsequently subjected to freeze-drying for 3 days until dried, resulting in the formation of a fine powder.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A membrane, the membrane comprising:
a polymeric material; and
a nanomaterial dispersed in the polymeric material, wherein the nanomaterial includes an amino-SiO₂ functionalized multi-walled carbon nanotube material, an elemental weight percentage of Si in the amino-SiO₂ functionalized multi-walled carbon nanotube material is greater than about 5 wt. %, and the membrane is hydrophilic.

2. The membrane of claim 1, wherein the polymeric material includes polylactic acid (PLA), and the membrane is a mixed matrix membrane.

3-5. (canceled)

6. The membrane of claim 1, wherein the elemental weight percentage of Si in the amino-SiO₂ functionalized multi-walled carbon nanotube material is greater than about 10 wt. %.

7. The membrane of claim 1, wherein the membrane exhibits a porosity ranging from about 70% to about 85%.

8. The membrane of claim 1, wherein the membrane exhibits a mean pore size ranging from about 50 nm to about 100 nm.

9. The membrane of claim 1, wherein the membrane exhibits a mean pore size ranging from about 65 nm to about 85 nm.

10. The membrane of claim 1, wherein the membrane exhibits a water contact angle of less than 80°.

11. A mixed matrix membrane, the mixed matrix membrane comprising:
a polymeric material including polylactic acid (PLA); and
a nanocomposite including multi-walled carbon nanotube material and titanium dioxide.

12-13. (canceled)

14. The mixed matrix membrane of claim 11, wherein the mixed matrix membrane exhibits a mean pore size ranging from about 50 nm to about 100 nm.

15. A method for forming a membrane, the method comprising:
distributing a nanomaterial in a solvent to form a first mixture, wherein the nanomaterial includes a multi-walled carbon nanotube material;
mixing one or more polymeric materials with the first mixture to form a second mixture;
introducing a non-solvent sufficient to induce phase separation; and
drying to form a hydrophilic membrane.

16. The method of claim 15, wherein the solvent includes a polar organic solvent, and the one or more polymeric materials include at least one of polylactic acid (PLA) and polyvinylpyrrolidone (PVP).

17. The method of claim 15, wherein the nanomaterial is hydrophilic, and the multi-walled carbon nanotube material includes a modified multi-walled carbon nanotube material.

18. The method of claim 15, wherein the one or more polymeric materials include polylactic acid (PLA), and the second mixture is heated sufficient to at least partially melt the polylactic acid (PLA).

19. The method of claim 15, further including sonicating and subjecting the second mixture to degasification to form a dope solution.

20. The method of claim 19, wherein the non-solvent includes water, and a weight percentage of nanomaterial in the dope solution ranges from about 0.2 wt. % to about 2 wt. %.

21. The membrane of claim 1, wherein the amino-SiO₂ functionalized multi-walled carbon nanotube material includes Si in the form of at least one of silica and amino-silica.

22. The membrane of claim 1, wherein the amino-SiO₂ functionalized multi-walled carbon nanotube material includes an amide group.

23. The membrane of claim 11, wherein a weight percentage of the nanocomposite in the membrane ranges from about 0.2 wt. % to about 3 wt. %.

24. The membrane of claim 11, wherein a weight percentage of the nanocomposite in the membrane ranges from about 1.5 wt. % to about 2.5 wt. %.
